(19) United States
(12) Patent Application Publication
(10) Pub. No.: US 2022/0126632 A1
(43) Pub. Date: Apr. 28, 2022

(54) PNEUMATIC TIRE

(71) Applicant: The Yokohama Rubber Co., LTD., Tokyo (JP)

(72) Inventor: Norifumi KAMEDA, Kanagawa (JP)

(21) Appl. No.: 17/310,768

(22) PCT Filed: Dec. 10, 2019
(86) PCT No.: PCT/JP2019/048347

§ 371 Date: Aug. 23, 2021

(30) Foreign Application Priority Data
Feb. 28, 2019 (JP) 2019-036870

(51) Int. Cl. B60C 15/06

(52) U.S. Cl. CPC B60C 15/0628; B60C 2015/0678; B60C 2015/0642

(57) ABSTRACT

A pneumatic tire has a rubber hardness higher than a rubber hardness of a rim cushion rubber, and includes a reinforced rubber between a turned back portion of a carcass layer and a sidewall rubber and between the turned back portion and the rim cushion rubber. A height H1 of a bead filler based on a measuring point of a rim diameter has a relationship of 0.10≤H1/SH≤0.23 with respect to a tire cross-sectional height SH. A height H2 of the reinforced rubber based on the measuring point of the rim diameter has a relationship of 0.40≤H2/SH≤0.55 with respect to the tire cross-sectional height SH. A cross-sectional area S2 of the reinforced rubber in a cross-sectional view in a tire meridian direction has a relationship of 1.10≤S2/S1≤2.70 with respect to a cross-sectional area S1 of the bead filler.

### TECHNICAL FIELD

The technology relates to a pneumatic tire and particularly relates to a pneumatic tire that can provide ride comfort performance and double lane change performance in a compatible manner.

### BACKGROUND ART

In recent pneumatic tires mounted on minivans, bead fillers having a tire cross-sectional height ratio that is lower than a typical tire cross-sectional height ratio (0.25 to 0.35) have been employed to improve the ride comfort performance of the tires. The technology described in Japan Unexamined Patent Publication No. H07-008602 is a known conventional pneumatic tire including such low bead fillers.

However, in a configuration provided with low bead fillers as described above, there is a problem that the tire cross-sectional height is relatively high, which leads to a deterioration of double lane change performance of the tire.

### SUMMARY

The present technology provides a pneumatic tire that can provide ride comfort performance and double lane change performance in a compatible manner.

A pneumatic tire according to an embodiment of the technology includes: a pair of bead cores; a pair of bead fillers disposed on an outer side in a radial direction of the pair of bead cores; a carcass layer wound and turned back toward an outer side in a tire width direction and wrapping the bead cores and the bead fillers; a pair of cross belts disposed on an outer side in the radial direction of the carcass layer; a tread rubber; a sidewall rubber; and a rim cushion rubber. The pneumatic tire includes a reinforced rubber having a rubber hardness higher than a rubber hardness of the rim cushion rubber, the reinforced rubber being disposed between a turned back portion of the carcass layer and the sidewall rubber and between the turned back portion of the carcass layer and the rim cushion rubber. A height H1 of the bead filler based on a measuring point of a rim diameter has a relationship of 0.10≤H1/SH≤0.23 with respect to a tire cross-sectional height SH. A height H2 of the reinforced rubber based on the measuring point of the rim diameter has a relationship of 0.40≤H2/SH≤0.55 with respect to the tire cross-sectional height SH. A cross-sectional area S2 of the reinforced rubber in a cross-sectional view in a tire meridian direction has a relationship of 1.10≤S2/S1≤2.70 with respect to a cross-sectional area S1 of the bead filler.

According to the pneumatic tire according to an embodiment of the technology, (1) a tire cross-sectional height ratio H1/SH of the bead filler is set lower than a typical tire cross-sectional height ratio (0.25 to 0.35). Accordingly, hardness in ride comfort is mitigated, and thus ride comfort performance of the tire is improved. Additionally, (2) the reinforced rubber is disposed between the turned back portion of the carcass layer and the sidewall rubber and between the turned back portion and the rim cushion rubber, and thus vibration damping is improved, and ride comfort performance of the tire is improved. At the same time, by reinforcing the bead portion with the reinforced rubber, a deterioration of double lane change performance of the tire due to the low bead filler described above is suppressed. Moreover, (3) a cross-sectional area ratio S2/S1 of the reinforced rubber is appropriately set. Accordingly, the effects of the reinforced rubber on vibration damping and reinforcement of the bead portion are ensured. In addition, degradation of ride comfort performance of the tire caused when the reinforced rubber is excessively large is suppressed. As a result, ride comfort performance and double lane change performance of the tire are advantageously provided in a compatible manner.

### BRIEF DESCRIPTION OF DRAWINGS

FIG. 1 is a cross-sectional view in a tire meridian direction illustrating a pneumatic tire according to an embodiment of the technology.

FIG. 2 is an enlarged view illustrating a bead portion and a sidewall portion of the pneumatic tire illustrated in FIG. 1.

FIG. 3 is an enlarged view illustrating the bead portion illustrated in FIG. 2.

FIG. 4 is an explanatory diagram illustrating a modified example of the pneumatic tire illustrated in FIG. 2.

FIGS. 5A and 5B are tables showing the results of performance tests of the pneumatic tire according to an embodiment of the technology.

### DETAILED DESCRIPTION

Embodiments of the technology are described in detail below with reference to the drawings. However, the technology is not limited to these embodiments. Moreover, constituents of the embodiments include elements that are substitutable while maintaining consistency with the technology, and obviously substitutable elements. Furthermore, the modified examples described in the embodiments can be combined as desired within the scope apparent to one skilled in the art.

### Pneumatic Tire

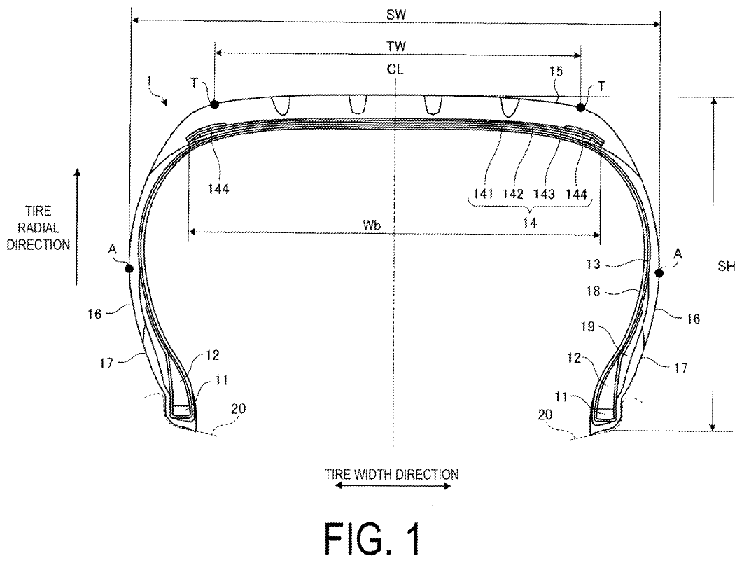

FIG. 1 is a cross-sectional view in a tire meridian direction illustrating a pneumatic tire according to an embodiment of the technology. The same drawing illustrates a cross-sectional view of a half region in a tire radial direction. FIG. 1 also illustrates a radial tire for a passenger vehicle, which has an aspect ratio of 60% or higher, as an example of a pneumatic tire.

In the same drawing, the cross-section in the tire meridian direction is defined as a cross-section of the tire taken along a plane that includes a tire rotation axis (not illustrated). Further, a tire equatorial plane CL is defined as a plane perpendicular to the tire rotation axis through a midpoint between measuring points in a tire cross-sectional width defined by JATMA (The Japan Automobile Tyre Manufacturers Association, Inc.). Furthermore, the tire width direction is defined as a direction parallel with the tire rotation axis, and the tire radial direction is defined as a direction perpendicular to the tire rotation axis. Additionally, a point T is a tire ground contact edge, and a point A is a tire maximum width position.

A pneumatic tire 1 includes an annular structure about the tire rotation axis as its center, and is provided with a pair of bead cores 11, 11, a pair of bead fillers 12, 12, a carcass layer 13, a belt layer 14, a tread rubber 15, a pair of sidewall rubbers 16, 16, a pair of rim cushion rubbers 17, 17, and an innerliner 18 (see FIG. 1).

The pair of bead cores 11, 11 include one or a plurality of bead wires made of steel and wound annularly multiple times and are embedded in bead portions to configure cores of the left and right bead portions. The pair of bead fillers 12, 12 are respectively disposed on an outer circumference of the pair of bead cores 11, 11 in the tire radial direction and reinforce the bead portions.

The carcass layer 13 has a single layer structure made of one carcass ply or a multilayer structure made of a plurality of carcass plies being layered and extends between the left and right bead cores 11, 11 in a toroidal shape, forming the framework of the tire. Additionally, both end portions of the carcass layer 13 are wound and turned back toward an outer side in the tire width direction so as to wrap the bead cores 11 and the bead fillers 12 and fixed. Moreover, the carcass ply of the carcass layer 13 is made by covering a plurality of carcass cords made of steel or an organic fiber material (for example, aramid, nylon, polyester, rayon, or the like) with coating rubber and performing a rolling process on the carcass cords, and has a cord angle (defined as an inclination angle in a longitudinal direction of the carcass cords with respect to a tire circumferential direction) of 80 degrees or more and 100 degrees or less.

The belt layer 14 is a multilayer structure including a plurality of belt plies 141 to 144, and is disposed by being wound around the outer circumference of the carcass layer 13. The belt plies 141 to 144 include a pair of cross belts 141, 142, a belt cover 143, and belt edge covers 144.

The pair of cross belts 141, 142 are made by covering a plurality of belt cords made of steel or an organic fiber material with coating rubber and performing a rolling process on the belt cords, and each have a cord angle with an absolute value of 25 degrees or more and 33 degrees or less. Further, the pair of cross belts 141, 142 have cord angles (defined as inclination angles in a longitudinal direction of the belt cords with respect to the tire circumferential direction) of opposite signs relative to each other and are layered such that the longitudinal directions of the belt cords intersect each other (so-called crossply structure). Furthermore, the pair of cross belts 141, 142 are disposed layered on an outer side in the tire radial direction of the carcass layer 13.

The belt cover 143 and the belt edge covers 144 are made by covering a plurality of belt cover cords made of steel or an organic fiber material with coating rubber, and each have a cord angle with an absolute value of 0 degrees or more and 10 degrees or less. Additionally, for example, a strip material is formed of one or a plurality of belt cover cords covered with coating rubber, and the belt cover 143 and the belt edge covers 144 are made by winding this strip material multiple times and in a spiral-like manner in the tire circumferential direction around outer circumferential surfaces of the cross belts 141, 142.

The tread rubber 15 is disposed on the outer circumference of the carcass layer 13 and the belt layer 14 in the tire radial direction and constitutes a tread portion. The pair of sidewall rubbers 16, 16 are disposed on the outer side in the tire width direction of the carcass layer 13 and constitute left and right sidewall portions. The pair of rim cushion rubbers 17, 17 extend from an inner side in the tire radial direction of the left and right bead cores 11, 11 and turned back portions of the carcass layer 13 toward the outer side in the tire width direction to constitute rim fitting surfaces of the bead portions.

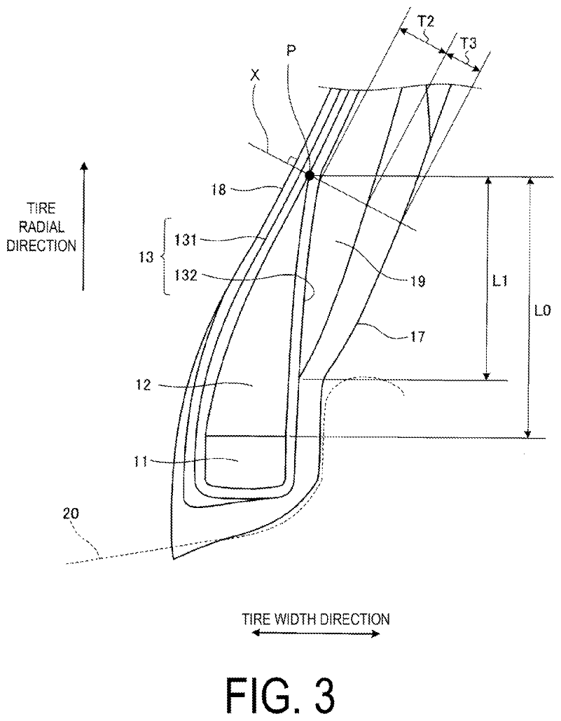

The innerliner 18 is an air permeation preventing layer disposed on the tire inner surface and covering the carcass layer 13, and suppresses oxidation caused by exposure of the carcass layer 13 and also prevents leaking of the air in the tire. In addition, the innerliner 18 is constituted by, for example, a rubber composition with butyl rubber as a main component, thermoplastic resin, a thermoplastic elastomer composition made by blending an elastomer component with a thermoplastic resin, and the like. Further, in the configuration of FIG. 1, an end portion on an inner side in the radial direction of the innerliner 18 is sandwiched between the carcass layer 13 and the rim cushion rubber 17, and extends to an inner side in the radial direction of the bead core 11 (see FIG. 3 described below).

Furthermore, in FIG. 1, a total tire width SW and a tire cross-sectional height SH have a relationship of 1.25≤SW/SH≤1.80. Consequently, the aspect ratio of the tire is set relatively high.

The total tire width SW is measured as a linear distance (including all portions such as letters and patterns on the tire side surface) between the sidewalls when the tire is mounted on a specified rim, inflated to the specified internal pressure, and in an unloaded state.

The tire cross-sectional height SH is half of a difference between a tire outer diameter and a rim diameter and is measured when the tire is mounted on a specified rim, inflated to a specified internal pressure, and in an unloaded state.

“Specified rim” refers to an “applicable rim” defined by the Japan Automobile Tyre Manufacturers Association Inc. (JATMA), a “Design Rim” defined by the Tire and Rim Association, Inc. (TRA), or a “Measuring Rim” defined by the European Tyre and Rim Technical Organisation (ETRTO). Additionally, “specified internal pressure” refers to a “maximum air pressure” defined by JATMA, to the maximum value in “TIRE LOAD LIMITS AT VARIOUS COLD INFLATION PRESSURES” defined by TRA, or to “INFLATION PRESSURES” defined by ETRTO. Additionally, “specified load” refers to a “maximum load capacity” defined by JATMA, the maximum value in “TIRE LOAD LIMITS AT VARIOUS COLD INFLATION PRESSURES” defined by TRA, or “LOAD CAPACITY” defined by ETRTO. However, in the case of JATMA, for a passenger vehicle tire, the specified internal pressure is an air pressure of 180 kPa, and the specified load is 88% of the maximum load capacity.

Moreover, a belt width Wb of the wider cross belt 141 preferably has a relationship of 1.10≤Wb/SH≤1.60 with respect to the tire cross-sectional height SH, and more preferably has a relationship of 1.20≤Wb/SH≤1.40. Consequently, the belt width Wb is set relatively wide.

The width of a belt ply is the distance in the direction of the tire rotation axis between the left and right end portions of each belt ply, measured when the tire is mounted on a specified rim, inflated to the specified internal pressure, and in an unloaded state.

Additionally, the belt width Wb of the wider cross belt 141 preferably has a relationship of 0.75≤Wb/SW≤0.95 with respect to the total tire width SW, and more preferably has a relationship of 0.80≤Wb/SW≤0.90.

### Reinforcement Structure of Bead Portion

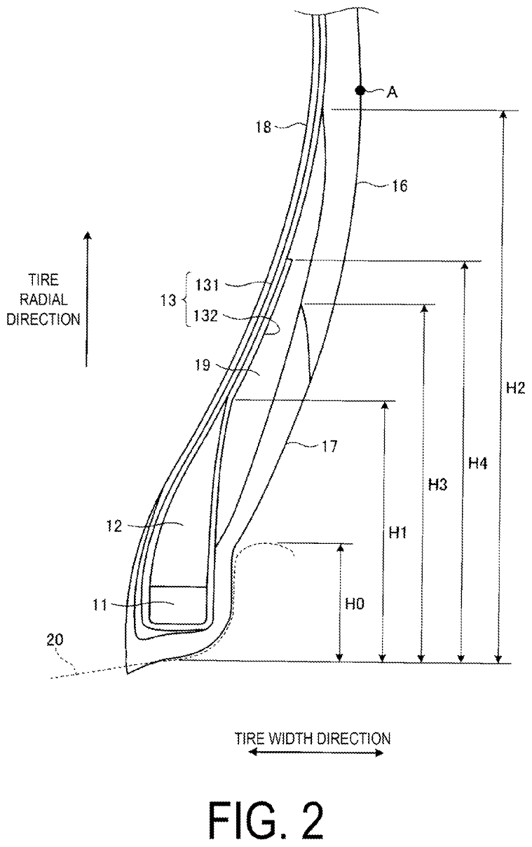

FIG. 2 is an enlarged view illustrating the tread portion and the sidewall portion of the pneumatic tire illustrated in FIG. 1. FIG. 3 is an enlarged view illustrating the bead portion illustrated in FIG. 2.

As illustrated in FIG. 1, the pneumatic tire 1 includes a pair of reinforced rubbers 19, 19. The reinforced rubber 19 has a rubber hardness equal to or greater than that of the bead filler 12, and has a rubber hardness higher than those of the sidewall rubber 16 and the rim cushion rubber 17.

Specifically, a rubber hardness Hs1 of the bead filler is preferably in a range of 70≤Hs1≤98, and is more preferably in a range of 75≤Hs1≤85. In contrast, a rubber hardness Hs2 of the reinforced rubber 19 is in a range of 88≤Hs2≤98. Additionally, the difference between the rubber hardness Hs2 of the reinforced rubber 19 and the rubber hardness Hs1 of the bead filler preferably has a relationship of 1≤Hs2−Hs1. The upper limit of the difference Hs2−Hs1 is not particularly limited, but is restricted by the range of the rubber hardness Hs1, Hs2.

Further, a rubber hardness Hs3 of the rim cushion rubber is in a range of 65≤Hs3≤75. Furthermore, the difference between the rubber hardness Hs2 of the reinforced rubber 19 and the rubber hardness Hs3 of the rim cushion rubber 17 has a relationship of 13≤Hs2−Hs3. The upper limit of the difference Hs2−Hs3 is not particularly limited, but is restricted by the range of the rubber hardness Hs3, Hs2.

The rubber hardness is measured in accordance with JIS (Japanese Industrial Standard) K6253.

In addition, the reinforced rubber 19 is disposed interposed between a turned back portion 132 of the carcass layer 13 and the sidewall rubber 16 and between the turned back portion 132 and the rim cushion rubber 17. Moreover, a pair of reinforced rubbers 19, 19 are disposed in the left and right bead portions, respectively.

In the configuration illustrated in FIG. 2, the carcass layer 13 has a single layer structure. As described above, the end portion of the carcass layer 13 is wound and turned back toward the outer side in the tire width direction so as to wrap the bead core 11 and the bead filler 12, and the turned back portion 132 of the carcass layer 13 is fixed in contact with a body portion 131 of the carcass layer 13. Further, the reinforced rubber 19 is disposed covering an end portion of the turned back portion 132 of the carcass layer 13 from the outer side in the tire width direction. Furthermore, the reinforced rubber 19 is disposed overlapping the bead filler 12 in the tire radial direction, and is in contact with an outer circumferential surface of the body portion 131 of the carcass layer 13 while extending in the tire radial direction.

Additionally, in FIG. 2, a height H1 of the bead filler 12 has a relationship of 0.10≤H1/SH≤0.23 with respect to the tire cross-sectional height SH (see FIG. 1). Thus, the height H1 of the bead filler 12 has a tire cross-sectional height ratio that is lower than a tire cross-sectional height ratio of a typical bead filler (0.25 to 0.35).

The height H1 of the bead filler is the distance from a measuring point of a rim diameter to an end portion on an outer side in the radial direction of the bead filler, and is measured when the tire is mounted on a specified rim, inflated to the specified internal pressure, and in an unloaded state.

In the configuration described above, the tire cross-sectional height ratio H1/SH of the bead filler 12 is set lower than a typical tire cross-sectional height ratio (0.25 to 0.35). Accordingly, hardness in ride comfort is mitigated, and thus ride comfort performance of the tire is improved. In addition, low-frequency road noise in the vicinity of 160 Hz is reduced, and thus noise performance of the tire is improved.

Additionally, a height H2 of the reinforced rubber 19 preferably has a relationship of 0.40≤H2/SH≤0.55 with respect to the tire cross-sectional height SH, and more preferably has a relationship of 0.43≤H2/SH≤0.49. The height H2 of the reinforced rubber is the distance from a measuring point of a rim radius to an end portion on an outer side in the radial direction of the reinforced rubber, and is measured when the tire is mounted on a specified rim, inflated to the specified internal pressure, and in an unloaded state.

Moreover, the difference between the height H2 of the reinforced rubber 19 and the height H1 of the bead filler 12 preferably has a relationship of 0.17≤(H2−H1)/SH≤0.45 with respect to the tire cross-sectional height SH, and more preferably has a relationship of 0.20≤(H2−H1)/SH≤0.35. Additionally, the difference between the height H2 of the reinforced rubber 19 and the height H1 of the bead filler 12 is preferably in a range of 30 mm≤H2−H1. The upper limit of the difference H2−H1 is not particularly limited, but is restricted by the range of the height H1, H2.

In the configuration described above, the reinforced rubber 19 is disposed between the turned back portion 132 of the carcass layer 13 and the sidewall rubber 16 and between the turned back portion 132 and the rim cushion rubber 17, and thus vibration damping is improved, and ride comfort performance of the tire is improved. Moreover, in a configuration provided with low bead filler as described above, there is a problem that the tire cross-sectional height is relatively high, which leads to a deterioration of double lane change performance of the tire. In this regard, in the configuration described above, by reinforcing the bead portion with the reinforced rubber 19, a deterioration of double lane change performance of the tire due to the low bead filler 12 described above is suppressed. As a result, both ride comfort performance and double lane change performance of the tire are provided in a compatible manner, and noise performance of the tire is also improved.

Additionally, in FIG. 3, an overlap L1 of the reinforced rubber 19 with respect to the bead filler 12 in the tire radial direction preferably has a relationship of 0.15≤L1/L0≤0.65 with respect to a radial length L0 of the bead filler 12, and more preferably has a relationship of 0.30≤L1/L0≤0.60. Thus, the overlap L1 of the reinforced rubber 19 is shorter than the radial length L0 of the bead filler 12, and an end portion on an inner side in the radial direction of the reinforced rubber 19 is located on an outer side in the tire radial direction of an outer circumferential surface of the bead core 11. Further, the overlap L1 of the reinforced rubber 19 is preferably in a range of 5.0 mm≤L1. The upper limit of the overlap L1 is not particularly limited, but is restricted by the condition of the aforementioned ratio L1/L0.

Furthermore, a cross-sectional area S2 of the reinforced rubber 19 in a cross-sectional view in the tire meridian direction preferably has a relationship of 1.10≤S2/S1≤2.70 with respect to a cross-sectional area S1 of the bead filler 12, and more preferably has a relationship of 1.25≤S2/S1≤1.60. As a result, the ratio S2/S1 of the cross-sectional area S2 of the reinforced rubber 19 is appropriately set. In other words, the cross-sectional area S1 of the reinforced rubber 19 is ensured by the aforementioned lower limit, and the effects of the reinforced rubber 19 on vibration damping and reinforcement of the bead portion are ensured. In addition, degradation of ride comfort performance and noise performance of the tire caused when the reinforced rubber 19 is excessively large are suppressed by the aforementioned upper limit.

Additionally, in FIG. 2, the difference between the height H1 of the bead filler 12 and a rim flange height H0 of a specified rim 20 is preferably in a range of 0 mm≤H1−H0, and is more preferably in a range of 5.0 mm≤H1−H0. Thus, the bead filler 12 extends on the outer side in the tire radial direction beyond the maximum height position of the specified rim 20. The upper limit of the difference H1−H0 is not particularly limited, but is restricted by other conditions of the height H1.

The rim flange height H0 is measured as a distance from a measuring point of a rim diameter to an end portion on an outer side in the radial direction of the specified rim.

Additionally, in FIG. 2, the difference between the height H2 of the reinforced rubber 19 and a height H3 of the rim cushion rubber 17 preferably has a relationship of 0.10≤(H2−H3)/SH≤0.30 with respect to the tire cross-sectional height SH, and more preferably has a relationship of 0.15≤(H2−H3)/SH≤0.25. Thus, the reinforced rubber 19 extends on the outer side in the tire radial direction beyond the maximum height position of the rim cushion rubber 17.

Moreover, the height H3 of the rim cushion rubber 17 has a relationship of 0.25≤H3/SH≤0.35 with respect to the tire cross-sectional height SH.

The height H3 of the rim cushion rubber is a distance from a measuring point of a rim diameter to an end portion on an outer side in the radial direction of the rim cushion rubber, and is measured when the tire is mounted on a specified rim, inflated to the specified internal pressure, and in an unloaded state.

Additionally, in FIG. 3, an imaginary line X passing through an end point P on the outer side in the radial direction of the bead filler 12 and orthogonal to a tire inner surface is defined. At this time, a thickness T2 of the reinforced rubber 19 and a thickness T3 of the rim cushion rubber 17 on the imaginary line X preferably have a relationship of 0.45≤T2/(T2+T3)≤0.70, and more preferably have a relationship of 0.50≤T2/(T2+T3)≤0.60. Moreover, the thickness T2 of the reinforced rubber 19 on the imaginary line X is preferably in a range of 3.0 mm≤T2≤5.0 mm.

Further, in FIG. 2, a height H4 of the turned back portion 132 of the carcass layer 13 has a relationship of 0.20≤H4/SH≤0.65 with respect to the tire cross-sectional height SH. Thus, the height H4 of the turned back portion 132 of the carcass layer 13 is appropriately set.

The height H4 of the turned back portion of the carcass layer is a distance from a measuring point of a rim diameter to an end portion on an outer side in the radial direction of the turned back portion, and is measured when the tire is mounted on a specified rim, inflated to the specified internal pressure, and in an unloaded state.

Furthermore, in FIG. 2, the difference between the height H4 of the turned back portion 132 of the carcass layer 13 and the height H1 of the bead filler 12 preferably has a relationship of 0.10≤(H4−H1)/SH with respect to the tire cross-sectional height SH, and more preferably has a relationship of 0.25≤(H4−H1)/SH. As a result, the height H4 of the turned back portion 132 of the carcass layer 13 is ensured, and tension of the carcass layer 13 is ensured. The upper limit of the ratio (H4−H1)/SH is not particularly limited, but is restricted by other conditions.

### MODIFIED EXAMPLES

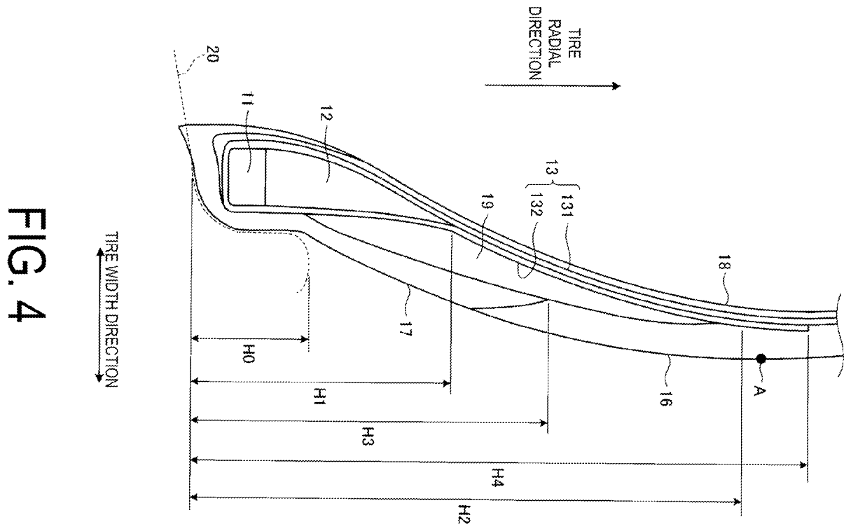

FIG. 4 is an explanatory diagram illustrating a modified example of the pneumatic tire illustrated in FIG. 2. In the same drawing, constituents that are identical to the constituents illustrated in FIG. 2 are denoted by the same reference signs, and explanations thereof are omitted.

In the configuration illustrated in FIG. 2, the carcass layer 13 has a so-called low turn-up structure, and the ratio H4/SH of the height H4 of the turned back portion 132 of the carcass layer 13 to the tire cross-sectional height SH is in a range of 0.20≤H4/SH≤0.45. In addition, the ratio H4/SH is preferably in a range of 0.25≤H4/SH≤0.35. Such a configuration is preferable in view of mitigating hardness in ride comfort.

In contrast, in the configuration of FIG. 4, the carcass layer 13 has a high turn-up structure, and the ratio H4/SH is in a range of 0.45≤H4/SH≤0.65. Further, in addition, the ratio H4/SH is preferably in a range of 0.50≤H4/SH≤0.60. Such a configuration is preferable in view of improving vibration damping.

### Effect

As described above, the pneumatic tire 1 includes the pair of bead cores 11, 11, the pair of bead fillers 12, 12 disposed on the outer side in the radial direction of the pair of bead cores 11, 11, the carcass layer 13 wound and turned back toward the outer side in the tire width direction and wrapping the bead cores 11 and the bead fillers 12, the pair of cross belts 141, 142 disposed on the outer side in the radial direction of the carcass layer 13, the tread rubber 15, the sidewall rubber 16, and the rim cushion rubber 17 (see FIG. 2). Further, the pneumatic tire 1 has a rubber hardness higher than a rubber hardness of the rim cushion rubber 17 and includes the reinforced rubbers 19 each disposed between the turned back portion 132 of the carcass layer 13 and the sidewall rubber 16 and between the turned back portion 132 and the rim cushion rubber 17 (see FIG. 3). Furthermore, the height H1 of the bead filler 12 based on a measuring point of a rim diameter has the relationship of 0.10≤H1/SH≤0.23 with respect to the tire cross-sectional height SH. Additionally, the height H2 of the reinforced rubber 19 based on a measuring point of a rim diameter has the relationship of 0.40≤H2/SH≤0.55 with respect to the tire cross-sectional height SH. Moreover, the cross-sectional area S2 of the reinforced rubber 19 in a cross-sectional view in the tire meridian direction has the relationship of 1.10≤S2/S1≤2.70 with respect to the cross-sectional area S1 of the bead filler.

In such a configuration, (1) the tire cross-sectional height ratio H1/SH of the bead filler 12 is set lower than a typical tire cross-sectional height ratio (0.25 to 0.35). Accordingly, hardness in ride comfort is mitigated, and thus ride comfort performance of the tire is improved. In addition, low-frequency road noise in the vicinity of 160 Hz is reduced, and thus noise performance of the tire is improved. Additionally, (2) the reinforced rubber 19 is disposed between the turned back portion 132 of the carcass layer 13 and the sidewall rubber 16 and between the turned back portion 132 and the rim cushion rubber 17, and thus vibration damping is improved, and ride comfort performance of the tire is improved. At the same time, by reinforcing the bead portion with the reinforced rubber 19, a deterioration of double lane change performance of the tire due to the low bead filler 12 described above is suppressed. Moreover, (3) the ratio S2/S1 of the cross-sectional area S2 of the reinforced rubber 19 is appropriately set. Accordingly, the effects of the reinforced rubber 19 on vibration damping and reinforcement of the bead portion are ensured. In addition, degradation of ride comfort performance and noise performance of the tire caused when the reinforced rubber 19 is excessively large are suppressed. As a result, ride comfort performance and double lane change performance of the tire are advantageously provided in a compatible manner, and noise performance of the tire is also advantageously improved.

Further, in the pneumatic tire 1, the difference between the height H2 of the reinforced rubber 19 and the height H1 of the bead filler 12 has the relationship of 0.17≤(H2−H1)/SH≤0.45 with respect to the tire cross-sectional height SH (see FIG. 2). Advantageously, the effects of the reinforced rubber 19 on vibration damping and reinforcement of the bead portion are ensured by the aforementioned lower limit. Advantageously, degradation of ride comfort performance and noise performance of the tire caused when the reinforced rubber 19 is excessively large are suppressed by the aforementioned upper limit.

Furthermore, in the pneumatic tire 1, the overlap L1 of the reinforced rubber 19 with respect to the bead filler 12 in the tire radial direction has the relationship of 0.15≤L1/L0≤0.65 with respect to the radial length L0 of the bead filler 12 (see FIG. 3). Advantageously, the effects of the reinforced rubber 19 on vibration damping and reinforcement of the bead portion are ensured by the aforementioned lower limit. Advantageously, degradation of ride comfort performance and noise performance of the tire caused when the reinforced rubber 19 is excessively large are suppressed by the aforementioned upper limit.

In addition, in the pneumatic tire 1, the difference between the rubber hardness Hs2 of the reinforced rubber 19 and the rubber hardness Hs1 of the bead filler 12 has the relationship of 1≤Hs2−Hs1. In such a configuration, the reinforced rubber 19 has a rubber hardness different from that of the bead filler 12, and thus it is advantageous that the effect of the reinforced rubber 19 on vibration damping is easily adjusted.

Moreover, in the pneumatic tire, the rubber hardness Hs2 of the reinforced rubber 19 is in the range of 88≤Hs2≤98. As a result, the rubber hardness Hs2 of the reinforced rubber 19 is advantageously ensured.

Further, in the pneumatic tire 1, the difference between the height H1 of the bead filler 12 and the rim flange height H0 of the specified rim has the relationship of 0 mm≤H1−H0 (see FIG. 2). As a result, advantageously, the height H1 of the bead filler 12 is ensured and the strength of the bead portion is ensured.

Furthermore, in the pneumatic tire 1, the difference between the height H2 of the reinforced rubber 19 and the height H3 of the rim cushion rubber 17 has the relationship of 0.10≤(H2−H3)/SH≤0.30 with respect to the tire cross-sectional height SH (see FIG. 2). Accordingly, it is advantageous that the height H2 of the reinforced rubber 19 is appropriately set.

Additionally, in the pneumatic tire 1, the height H3 of the rim cushion rubber 17 based on a measuring point of a rim diameter has the relationship of 0.25≤H3/SH≤0.35 with respect to the tire cross-sectional height SH (see FIG. 2). Accordingly, it is advantageous that the height H3 of the rim cushion rubber 17 is appropriately set.

Further, in the pneumatic tire 1, the imaginary line X passing through the end point P on the outer side in the radial direction of the bead filler 12 and orthogonal to the tire inner surface is defined, and the thickness T2 of the reinforced rubber 19 and the thickness T3 of the rim cushion rubber 17 on the imaginary line X have the relationship of 0.50≤T2/(T2+T3)≤0.67 (see FIG. 3). Accordingly, it is advantageous that the thickness T2 of the reinforced rubber 19 is appropriately set with respect to the thickness T3 of the rim cushion rubber 17.

Furthermore, in the pneumatic tire 1, the difference between the rubber hardness Hs2 of the reinforced rubber 19 and the rubber hardness Hs3 of the rim cushion rubber 17 has the relationship of 13≤Hs2−Hs3. Accordingly, it is advantageous that the rubber hardness Hs2 of the reinforced rubber 19 is appropriately set.

Additionally, in the pneumatic tire 1, the height H4 of the turned back portion 132 of the carcass layer 13 has the relationship of 0.20≤H4/SH≤0.65 with respect to the tire cross-sectional height SH (see FIG. 2). Accordingly, it is advantageous that the height H4 of the turned back portion 132 of the carcass layer 13 is appropriately set.

Moreover, in the pneumatic tire 1, the difference between the height H4 of the turned back portion 132 of the carcass layer 13 and the height H1 of the bead filler 12 based on a measuring point of a rim diameter has the relationship of 0.10≤(H4−H1)/SH with respect to the tire cross-sectional height SH (see FIG. 2). Accordingly, it is advantageous that the height H4 of the turned back portion 132 of the carcass layer 13 is ensured and that tension of the carcass layer 13 is ensured.

Further, in the pneumatic tire 1, the belt width Wb of the wider cross belt 141 has the relationship of 1.10≤Wb/SH≤1.60 with respect to the tire cross-sectional height SH (see FIG. 1). Advantageously, ride comfort performance and noise performance of the tire are provided in a compatible manner by the aforementioned lower and upper limits.

Furthermore, in the pneumatic tire 1, the belt width Wb of the wider cross belt 141 has the relationship of 0.75≤Wb/SW≤0.95 with respect to the total tire width SW (see FIG. 1). Advantageously, ride comfort performance and noise performance of the tire are provided in a compatible manner by the aforementioned lower and upper limits.

Additionally, the pneumatic tire 1 is a radial tire for a passenger vehicle, which has an aspect ratio of 60% or higher. The aforementioned configuration is applied to a tire for a passenger vehicle, which has a high aspect ratio, and thus advantageously, the aforementioned effect that ride comfort performance and double lane change performance are improved by the reinforced rubber 19 is remarkably attained.

### EXAMPLES

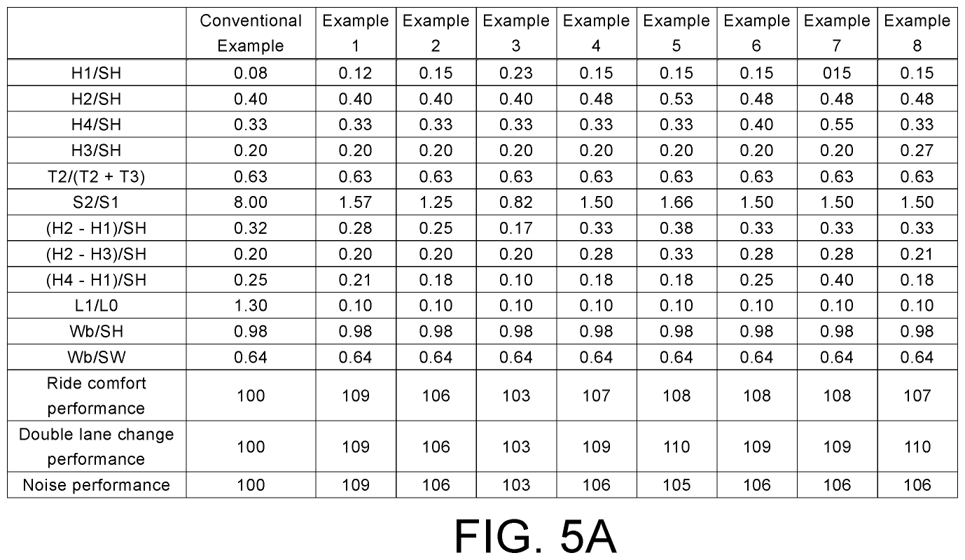

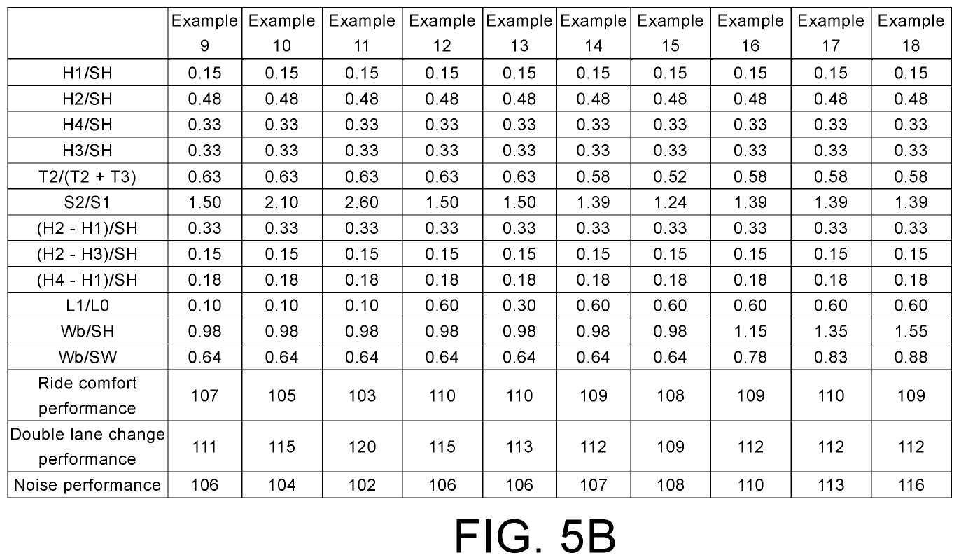

FIGS. 5A and 5B are tables showing the results of performance tests of pneumatic tires according to the embodiment of the technology.

In the performance tests, (1) noise performance, (2) double lane change performance, and (3) noise performance were evaluated for a plurality of test tires. Further, the test tires having a tire size of 235/65R17 are mounted on rims having a rim size of 17×7J, and an internal pressure of 240 kPa and a load specified by JATMA are applied to the test tires. Furthermore, the test tires are mounted on all wheels of a front-wheel drive minivan vehicle, serving as a test vehicle, of 3.5 L displacement.

(1) In an evaluation on ride comfort performance, a test vehicle travels on a dry road surface of a test course, and a specialized test driver performs feeling evaluation on hardness in ride comfort and vibration damping. Results of the evaluation are expressed as index values and evaluated with Conventional Example being assigned as the reference (100). In this evaluation, larger values are preferable.

(2) In an evaluation on double lane change performance, a test vehicle coasts on a dry road surface of a test course, and the vehicle is subjected to continuous right and left lane changes along a predetermined driving line.

Then, the evaluation is performed by measuring an approaching limit speed to the test course. Results of the evaluation are expressed as index values and evaluated with Conventional Example being assigned as the reference (100). In this evaluation, larger values are preferable.

(3) In an evaluation on noise performance, a test vehicle coasts on a rough road surface of a test course at 10 km/h to 20 km/h, and a test driver performs sensory evaluation on cabin noise (road noise). Results of the evaluation are expressed as index values and evaluated with Conventional Example being assigned as the reference (100). In this evaluation, larger values are preferable.

The test tires of Examples include the configurations of FIGS. 1 and 2, and each of the tires includes the bead fillers 12 having the low height H1, and the reinforced rubbers 19. Additionally, the tire cross-sectional height SH is 150 mm, the rubber hardness Hs1 of the bead filler 12 is 90, the rubber hardness Hs2 of the reinforced rubber 19 is 95, the rubber hardness Hs3 of the rim cushion rubber is 70, and the rubber hardness of the sidewall rubber 16 is 53.

In the test tire of Example 1, the test tire of Conventional Example is set such that the ratio S2/S1 of the cross-sectional area S2 of the reinforced rubber 19 to the cross-sectional area S1 of the bead filler is set to a very large value.

As can be seen from the test results, ride comfort performance, double lane change performance, and noise performance of the tire are apparently improved in the test tires of Examples.

1. A pneumatic tire, comprising:
a pair of bead cores;
a pair of bead fillers disposed on an outer side in a radial direction of the pair of bead cores;
a carcass layer wound and turned back toward an outer side in a tire width direction and wrapping the bead cores and the bead fillers;
a pair of cross belts disposed on an outer side in the radial direction of the carcass layer;
a tread rubber;
a sidewall rubber; and,
a rim cushion rubber,
the pneumatic tire comprising a reinforced rubber having a rubber hardness higher than a rubber hardness of the rim cushion rubber, the reinforced rubber being disposed between a turned back portion of the carcass layer and the sidewall rubber and between the turned back portion of the carcass layer and the rim cushion rubber,
a height H1 of the bead filler based on a measuring point of a rim diameter having a relationship of 0.10≤H1/SH≤0.23 with respect to a tire cross-sectional height SH,
a height H2 of the reinforced rubber based on the measuring point of the rim diameter having a relationship of 0.40≤H2/SH≤0.55 with respect to the tire cross-sectional height SH, and,
a cross-sectional area S2 of the reinforced rubber in a cross-sectional view in a tire meridian direction having a relationship of 1.10≤S2/S1≤2.70 with respect to a cross-sectional area S1 of the bead filler.

2. The pneumatic tire according to claim 1, wherein a difference between the height H2 of the reinforced rubber and the height H1 of the bead filler has a relationship of 0.17≤(H2−H1)/SH≤0.45 with respect to the tire cross-sectional height SH.

3. The pneumatic tire according to claim 1, wherein an overlap L1 of the reinforced rubber with respect to the bead filler in a tire radial direction has a relationship of 0.15≤L1/L0≤0.65 with respect to a radial length L0 of the bead filler.

4. The pneumatic tire according to claim 1, wherein a difference between a rubber hardness Hs2 of the reinforced rubber and a rubber hardness Hs1 of the bead filler has a relationship of 1≤Hs2−Hs1.

5. The pneumatic tire according to claim 1, wherein a rubber hardness Hs2 of the reinforced rubber is within a range of 88≤Hs2≤98.

6. The pneumatic tire according to claim 1, wherein a difference between the height H1 of the bead filler and a rim flange height H0 of a specified rim has a relationship of 0 mm≤H1−H0.

7. The pneumatic tire according to claim 1, wherein a difference between the height H2 of the reinforced rubber and a height H3 of the rim cushion rubber has a relationship of 0.10≤(H2−H3)/SH≤0.30 with respect to the tire cross-sectional height SH.

8. The pneumatic tire according to claim 1, wherein a height H3 of the rim cushion rubber based on the measurement point of the rim diameter has a relationship of 0.25≤H3/SH≤0.35 with respect to the tire cross-sectional height SH.

9. The pneumatic tire according to claim 1, wherein an imaginary line X passing through an end point P on an outer side in the radial direction of the bead filler and orthogonal to a tire inner surface is defined, and a thickness T2 of the reinforced rubber and a thickness T3 of the rim cushion rubber on the imaginary line X have a relationship of 0.45≤T2/(T2+T3)≤0.70.

10. The pneumatic tire according to claim 1, wherein a difference between a rubber hardness Hs2 of the reinforced rubber and a rubber hardness Hs3 of the rim cushion rubber has a relationship of 13≤Hs2−Hs3.

11. The pneumatic tire according to claim 1, wherein a height H4 of the turned back portion of the carcass layer has a relationship of 0.20≤H4/SH≤0.65 with respect to the tire cross-sectional height SH.

12. The pneumatic tire according to claim 1, wherein a difference between a height H4 of the turned back portion of the carcass layer and the height H1 of the bead filler based on the measuring point of the rim diameter has a relationship of 0.10≤(H4−H1)/SH with respect to the tire cross-sectional height SH.

13. The pneumatic tire according to claim 1, wherein a belt width Wb of the cross belt that is wider has a relationship of 1.10≤Wb/SH≤1.60 with respect to the tire cross-sectional height SH.

14. The pneumatic tire according to claim 1, wherein a belt width Wb of the cross belt that is wider has a relationship of 0.75≤Wb/SW≤0.95 with respect to a total tire width SW.

15. The pneumatic tire according to claim 1, wherein the pneumatic tire is a radial tire for a passenger vehicle having an aspect ratio of 60% or higher.
